(19) United States
(12) Patent Application Publication
(10) Pub. No.: US 2021/0111548 A1
(43) Pub. Date: Apr. 15, 2021

(54) UTILITY LINE SUPPORT STRUCTURE

(71) Applicant: SLINGCO LIMITED, Rochdale (GB)

(72) Inventors: Gerald Antony WOODBRIDGE, Rochdale (GB); Jem Howard MOSLEY, Rochdale (GB)

(21) Appl. No.: 17/068,970

(22) Filed: Oct. 13, 2020

Related U.S. Application Data
(60) Provisional application No. 62/914,786, filed on Oct. 14, 2019.

(51) Int. Cl. H02G 7/05; E04H 12/24

(52) U.S. Cl. CPC H02G 7/05; E04H 12/24

(57) ABSTRACT

A utility line support structure has a fiber-reinforced beam in which the beam includes a first member and a second member. An interior of the beam is between the first and second members. The beam has or receives at least one pair of holes. The holes include a first hole arranged in the first member and a second hole arranged in the second member. The central axes of the holes are aligned. A clamping system has a first portion and a second portion wherein the first portion has an insertion member insertable into the first hole and into the interior of the beam and a second portion having an insertion member that is insertable through the second hole and into the interior of the beam.

### CROSS-REFERENCE TO RELATED APPLICATIONS

The present application claims priority from U.S. Patent Application Ser. No. 62/914,786, filed on Oct. 14, 2019, and entitled “Utility Line Support Structure”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to utility line support structures. In particular, the present invention relates to such support structures that include a structural member for mounting to a pole or similar ground-extending structure. The present invention also relates to structural members that support an electrical conductor or other line.

### 2. Description of Related Art Including Information Disclosed Under 37 CFR 1.97 and 37 CFR 1.98

In the past, various patents and patent application publications have issued with respect to such utility line support structures. For example, U.S. Pat. No. 6,834,469, issued on Dec. 28, 2004 to Fingerson et al, discloses a utility line support structure which has a hollow reinforcing member placed entirely within a fiber-reinforced beam. Ends of the hollow reinforcing member abut opposed interior surfaces of the beam. An internal diameter of the hollow reinforcing member is the same as a diameter of transverse holes through the beam. An external diameter of the hollow reinforcing member is greater than the diameter of the transverse holes. Accordingly, for mounting the utility line support structure, a bolt is inserted through the transverse holes so as to transmit a compressive load from the opposed exterior surfaces of the beam axially to the hollow reinforcing member for reinforcement of the beam. During production, placement of the hollow reinforcing members in the beam may be complex. This is particularly true since the beam is elongate. Moreover, after production, retrofitting of additional holes with hollow reinforcing member reinforcements can be complex, particularly since the beam is often filled with a filler (such as foam) for moisture-proofing, strength and enhancement.

U.S. Pat. No. 5,605,017, issued on Feb. 25, 1997 to Fingerson et al., shows a utility line support structure for use as a tangent crossarm or dead end which includes a hollow fiber-reinforced beam with a bushing inserted into a transverse hole in the beam. The bushing includes a hollow inner member for receiving a bolt and a pair of integral washers arranged on opposite sides of the inner member and against an outer surface of the beam. The hollow inner member and the integral washers cooperate so as to support axial loads applied to the bolt. End caps extend over opposite ends of the beam to seal the beam so as to prevent moisture from entering the beam.

U.S. Pat. No. 4,194,080, issued on Mar. 18, 1990 to R. F. Meisberger, describes a utility line support structure having a tubular pole adapted to be either directed to extend upright from the ground, a pair of Y-configured arms extending upwardly and outwardly from the top of the pole, a connector means connecting to the bottom of the Y-configured arms to the top of the pole, and a crossarm connected between the upper portion of the Y-configured arms. The Y-configured arms are constructed of a structural element having a generally C-shaped cross-section. The cross arm comprises a truss with lattice work.

U.S. Pat. No. 4,314,434, issued on Feb. 9, 1982 to R. F. Meisberger, teaches a utility line support structure having a pair of legs extending upwardly with respect to the ground and an H-shaped frame. The legs are made of structural elements having a web, a pair of side walls extending right angles from a break line between the web and each side wall, and a pair of inturned flanges extending at right angles from a break line between each flange and its associated side wall. The flanges are parallel to the web and have edges defined in a slot therebetween so that the legs have a generally C-shaped cross section.

U.S. Pat. No. 10,597,894, issued on Mar. 24, 2020 to Burbank et al., discloses a support member supporting electrical power lines. The support member includes a support pole having a first end and a second end, and a crossarm attached to the support pole adjacent the first end of the support pole. The crossarm has a first end, a second end, and one or more side walls extending between the first and second ends of the crossarm. The side walls of the crossarm define an elongated interior space. The support system further includes an internal conduit formed in the interior space of the crossarm. The internal conduit extends along an axial direction of the crossarm. The internal conduit is made from an insulative material.

U.S. Pat. No. 8,474,221, issued on Jul. 2, 2013 to P. Ceko, provides an environmentally friendly fiberglass utility pole that comes in three sections that are telescoped one around the other so as to provide a strong, wind and bearing-resistance structure. Each of the three sections has alternating protruding and intruding surfaces that are slip-fit together to provide maximum strength.

U.S. Pat. No. 4,728,749, issued on Mar. 1, 1988 to J. K. Knight, shows a utility pole assembly in which ceramic elements are clamped together by means of a tension rod to form a crossarm assembly. The elements are provided with recesses which receive electrical conductors. Clips are provided so as to retain the conductors within the recesses.

It is an object of the present invention to provide a utility line structure in which the beam can be conveniently reinforced without needing to insert reinforcing members through the ends of the beams.

It is another object of the present invention to provide a utility line structure in which loads are transmitted through first and second portions of the beam.

It is another object of the present invention to provide a utility line structure in which the clamping system is convenient to assemble.

It is another object of the present invention to provide a utility line structure which makes it possible to retrofit additional clamping systems.

These and other objects and advantages of the present invention will become apparent from a reading of the attached specification and appended claims.

### BRIEF SUMMARY OF THE INVENTION

The present invention is a utility line support structure that has a fiber-reinforced beam. The beam includes a first member and a second member. An interior of the beam is defined between the first and second members. The fiber-reinforced beam has or receives at least one pair of holes including a first hole arranged in the first member and a second hole arranged in the second member. A central axis of the first hole and a central axis of the second hole are aligned.

A clamping system is provided which includes a first portion and a second portion. The first portion has an insertion member at a distal end thereof that is adapted for insertion through the first hole and into the interior of the beam. A flanged member is at a proximal end has a greater diameter than the first hole. The first portion is arrangeable in an engaged position in which the insertion member is inserted through the first hole with the flanged member engaging an outer surface of the first member of the beam. The second portion has an insertion member at a distal end thereof adapted for insertion through the second hole and into the interior of the beam. Another flanged member is at a proximal end. This flanged member has a greater diameter than the second hole. The second portion is arrangeable in an engaged position in which the insertion member is inserted through the second hole with the flanged member engaging an outer surface of the second member of the beam. The distal ends of the insertion members of the first portion and the second portion engage each other when the first portion and the second portion are arranged in the engaged position.

As used herein, the term “flanged member engaging an outer surface of the beam” or similar term, can refer to the flanged member of the first or second portions arranged in direct contact with the beam or in contact with an intermediary member. This can include a washer or other such member.

By configuring the clamping system to be inserted into the interior of the beam via the transverse holes, and with the first and second portions engaging each other within the beam, the beam can be conveniently reinforced without need to insert reinforcing members to the ends of the beams. In particular, a load is transmitted through the first and second portions via the flanged member. The clamping system can therefore be more conveniently and easily assembled. Additionally, retrofitting of additional clamping system is made possible.

The beam can be hollow and the first and second members are interconnected by one or more other members. The beam can have any suitable cross-sectional configurations, including rectangular (e.g. a square) or other quadrilateral.

The first and second portions of the clamping system can be hollow to receive a connecting member therethrough when both are in the engaged position. By implementing hollow first and second portions, the connecting member can be conveniently inserted therethrough so as to enable clamping together of the first and second portions for connecting of the utility line support structure to another support structure, such as a pole or tower.

Within the concept of the present invention, the connecting member can comprise a bolt having a head at the first end and a thread at the second end. The thread threadedly engages a complementary threaded member. The threaded member can be a nut or integrated as part of a bracket or a tower or a pole. The flanged members of the first portion and the second portion are clamped to the first and second members of the beam in order to mount the support structure to a pole or tower.

Each insertion member can include an engagement portion to transfer the load in an axial direction between the first and second portions. In particular, the engagement portion can be configured to restrain axial relative movement of the first and second portions. By configuring the engagement portion for transmission of axial load between the first and second portions, a compressive force from clamping can be supported by the clamping system.

The engagement portion of the first portion can be complementary in shape to the engagement portion of the second portion. By implementing engagement portions that are complementary in shape, the engagement portions can be conveniently engaged with each other.

When moving to the engaged position, one of the engagement portions of the first and second portions is slidably engageable with the other of the engagement portions of the first and second portions. By implementing slidably engageable engagement portions, the portions are conveniently engaged when the first and second portions are inserted through opposed holes.

One of the engagement portions of the first and second portions can include a collar to receive an insert of the other of the engagement portions of the first and second portions. A first and/or second end of the collar abuts a first and/or second end of the insert in the engaged position. A slidable engageable connection can be conveniently achieved by implementing this collar-and-insert configuration.

In the engaged position, the engagement portions of the insertion members can be configured with a peripheral diameter substantially the same as the peripheral diameter of the rest of the insertion members. By implementing the insertion members of the first and second portions to form, when engaged, the section that has the same outer diameters the rest of the insertion members of the first and second portions, the insertion portions can be conveniently located in the fiber-reinforced beam by selecting the first and second holes to have the same peripheral diameter. This configuration can be particularly advantageous when the fiber-reinforced beam includes a foam-field interior since a single diameter hole may extend through the foam (e. g. a different diameter hole is not required proximal the engagement members).

In the engaged position, the engagement portions of the insertion members are configured with an interior diameter substantially the same as the interior diameter of the rest of the insertion members. When the insertion members of the first and second portions form, when engaged, a section that is the same interior diameter as the rest of the insertion members of the first and second portions, a bolt (or other member) can be conveniently insert through the insertion member.

A coupling surface of the insert or the collar can include a cut-out portion arranged at a tip region of the insert or collar. The cut-out portion can extend parallel to the central axis. This cut-out portion (e. g. a narrowing section in the instance of the insert or a widening section in the instance of the collar) allows more convenient insertion of the inserted into the collar because of this greater tolerance.

The cut-out portion can also include a ridge. The ridge helps to stabilize the connection of the insert in collar via abutting and guiding the opposed member. This does not significantly compromise the convenient insertion of the insert into the collar. The ridge has a curved profile so as to assist with the more convenient insertion of the insert into the collar.

The ridges, in particular the tips thereof, of the collar and insert are arranged to overlap each other when viewed along the central axis. The ridges can be arranged such that they are drawn past each other as the collar and insert move to the engaged position. The ridges are arranged to overlap to the extent that they mechanically deform (e.g. elastically or plastically) when they are drawn past or in engagement with each other as the collar and insert move to the engaged position. This mechanical deformation provide some mechanical connection of the insert to the collar. This enables the first member and the second member to be pressed together and retained in position before receiving the bolt.

The other of the insert or collar which does not include the cut-out includes a ridge extending from a coupling surface thereof that is dimensioned for accommodation in the cut-out. The ridge helps to stabilize the connection of the insert end collar without significantly compromising convenient insertion of the insert into the collar. The ridge has a curved profile to assist with the more convenient insertion of the insert into the collar.

The insert that includes the cut-out portion has a narrowing section. This narrowing section extends from a first region (which defines the coupling surface). The ridge extends radially outwardly from the narrowing section and has a peak diameter which is less than the diameter of the first region. The coupling surface of the collar includes the ridge arranged proximal a base of the collar such that the ridge extends in a radially inward direction from the coupling surface and extends to a diameter suitable for accommodation in the narrowing section of the insert.

The fiber-reinforced beam can include a foam material arranged between the first member and the second member. The foam material increases the structural rigidity of the fiber-reinforced beam.

Multiple pairs of holes can be provided through the beam. Each of the pair of holes is located at a different location. Each of the pairs of holes is associated with a clamping system. The pairs of holes are arranged on the first and second portions of the beam or on members interconnecting the first and second portions.

The present invention also is a method of assembling a utility line support structure. This method comprises: (1) inserting an insertion member of a first portion of a clamping system through a first hole in a fiber-reinforced beam and into an interior of the beam; (2) engaging a flanged member of the first portion with an outer surface of the fiber-reinforced beam; (3) inserting an insertion member of the second portion of a clamping system through a second hole in the fiber-reinforced beam and into an interior of the beam; (4) engaging a flanged member of the second portion with an outer surface of the beam; and (5) engaging distal ends of the insertion members with each other.

In this method, the method can include inserting a bolt through the first and second portions. This method can include forming the first and second holes at a location dictated by a user or customer. This location is different from the location of forming the at least one of the clamping system and fiber-reinforced beam. This allows holes to be formed at positions on the utility line support structure specific to the requirements required at site.

Certain pairs of holes can be formed at the customer-desired location. Other pairs of holes are formed at the location of forming at least one of the clamping system and the fiber-reinforced beam.

This foregoing Section is intended to describe, with particularity, the preferred embodiments of the present invention. Various modifications of the preferred embodiments can be made within the scope of the appended claims without departing from the true spirit of the invention. This Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective exploded view of the utility line support structure of the present invention.

FIG. 2A is a top view of the first portion of the clamping system of the utility line support structure of FIG. 1.

FIG. 2B is a side cross-sectional view as taken along lines A-A of FIG. 2A.

FIG. 3A is a top view of a second portion of a clamping system of the utility line support structure of FIG. 1.

FIG. 3B is a side cross-sectional view as taken along lines A-A of FIG. 3A.

FIGS. 4 and 5 are perspective cross-sectional views of the utility line support structure of FIG. 1.

FIGS. 6A-6C are side cross-sectional views of an embodiment of the clamping system of the utility line support structure of FIG. 1. In particular, FIGS. 6B and 6C are enlarged views of the indicated portions in FIG. 6A, which include “B” and “C” to designate the associated figure.

FIGS. 7A-7C are side cross-sectional views of an embodiment of the clamping system of the utility line support structure of FIG. 1. In particular, FIGS. 7B and 7C are enlarged views of the indicated portions in FIG. 7A, which includes “B” and “C” to designate the associated figure.

### DETAILED DESCRIPTION OF THE INVENTION

The present disclosure may be better understood in view of the following explanations: As used herein, the term “utility line support structure” refers to a structure that is suitable for supporting a utility line as defined herein. The suitability may be defined in terms of sufficient structural rigidity to support the line and/or sufficient electrical insulating capability.

As used herein, the term “utility line” refers to an electrical line for transmission of electrical energy. The electrical line may have a diameter of between 5 to 50 mm.

As used herein the term “fiber reinforced beam” refers to a beam composed of or including a fibrous component. This fibrous component comprises a glass fiber reinforced polymer (GFRP) or other suitable composition. The fiber reinforcement can be beneficial due to low electrical conductivity.

As used herein, the term “hollow” in respect of the fiber reinforced beam refers to an interior volume defined by exterior surfaces of the beam. “Hollow” includes a volume between a beam composed of at least two opposed members. In embodiments, the beam is hollow, wherein the first and second members are interconnected by one or more other members. The beam can have any suitable cross-sectional configuration, including rectangular (e.g. a square), or other quadrilateral.

As used herein, the term “foam material” refers to a material with trapped pockets of gas in a solid. The foam is formatted from a variety of compositions, including polyurethane foam.

As used herein, the term “telegraph pole or tower” refers to a structure that extends from the ground for support of utility lines. It comprises a single pole or multi member formation. An example is Soudafoam PWB-4506, which is supplied by Soudal NV: https://www.soudal.com/

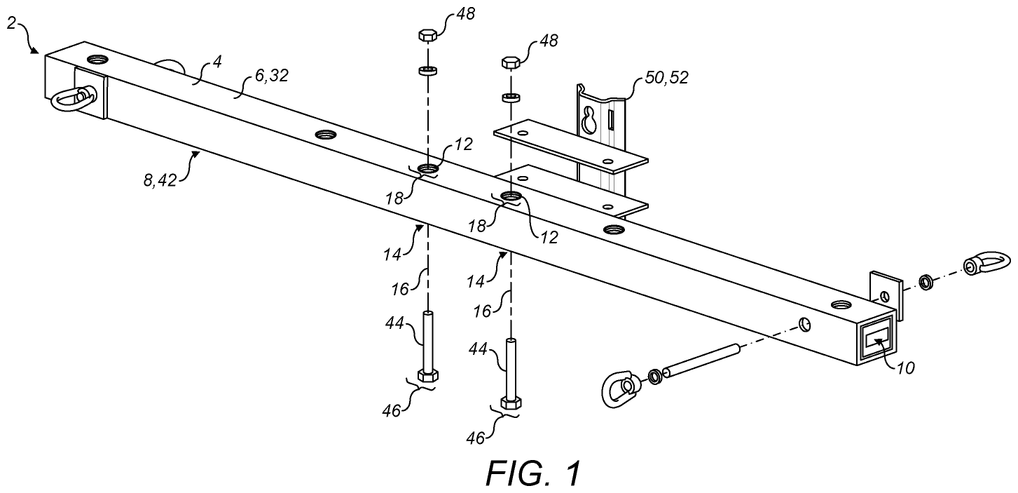

Referring to FIGS. 1 to 5, a utility line support structure 2 comprises a fiber reinforced beam 4. In variant embodiments, which are not illustrated, the beam can be formed of other materials, including an alloy. The beam 4 includes a first member 6 and a second member 8. An interior 10 of the beam is defined as between first member 6 and second member 8.

The fiber reinforced beam 4 includes or is adapted to receive at least one pair of holes comprising a first hole 12 arranged in the first member 6 and a second hole 14 arranged in the second member 8, wherein a central axis 16 of the first and second holes are aligned. In other words, the first hole 12 and the second hole 14 have the same (or substantially the same) central axis 16.

The utility line support structure 2 comprises a clamping system 18 including a first portion 20 and a second portion 22. The first portion 20 comprises, at a distal end 24 an insertion member 26 adapted for insertion though the first hole 12 and into the interior 10 of the beam 4, and at a proximal end 28 a flanged member 30 of greater diameter than the first hole 12. The first portion 20 is arrangeable in an engaged position (shown in the FIG. 4), wherein the insertion member 26 is inserted through the first hole 12 with the flanged member 30 engaging an outer surface 32 of the first member 6 of the beam 4. The second portion 22 comprises, at a distal end 34, an insertion member 36 adapted for insertion though the second hole 14 and into the interior 10 of the beam 4, and at a proximal end 38 a flanged member 40 of greater diameter than the second hole 14. In the above, distal and proximal is be defined in respect of the beam walls.

The second portion 22 is arrangeable in an engaged position (shown in the FIG. 4), wherein the insertion member 36 is inserted through the second hole 14 with the flanged member 40 engaging an outer surface 42 of the second member 8 of the beam 4.

With the first portion 20 and second portion 22 arranged in the engaged position, distal ends 24, 34 of the first portion 20 and second portion 22 engage each other.

In variant embodiments, which are not illustrated, although the beam 4 is illustrated as comprising a first member 6 and an opposed second member 8 which are interconnected by corresponding opposed members to form a rectangular section, other configurations include: just the first member and an opposed second member, wherein a foam material holds said members apart from each other, and; other sectional profiles, including square, triangular, or curved.

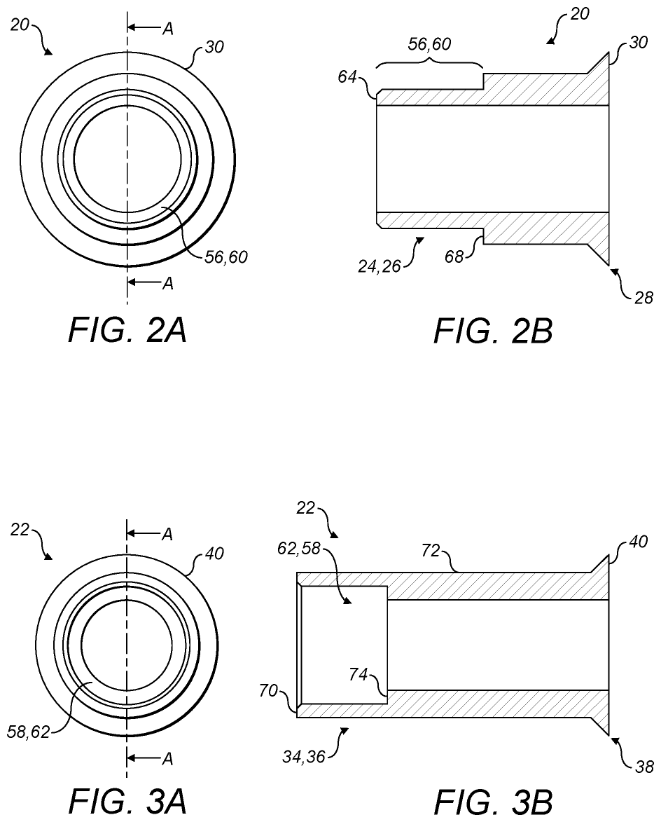

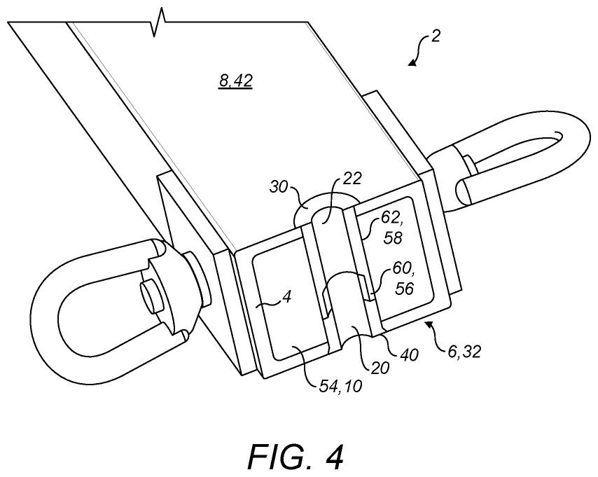

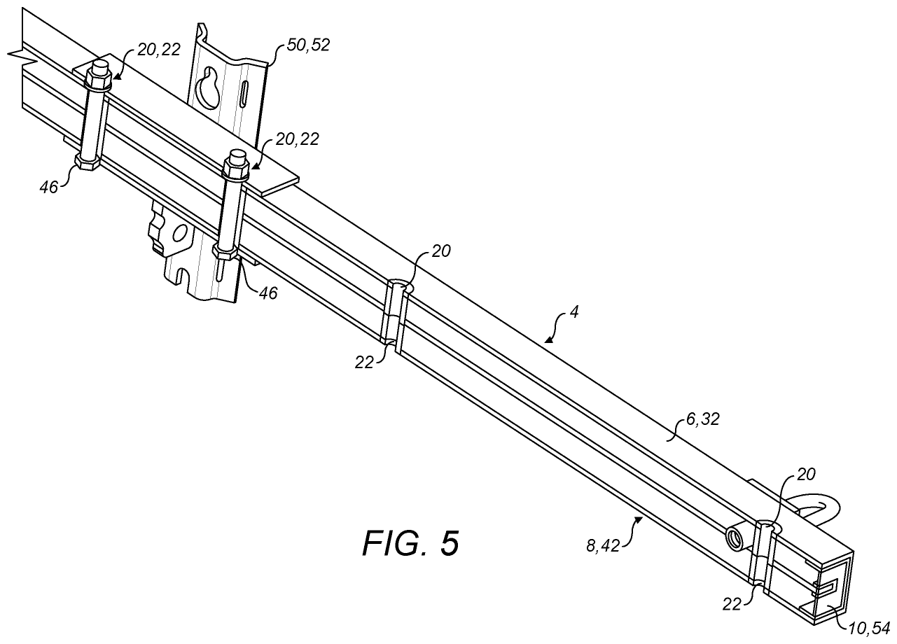

Referring to FIGS. 2 and 3, in embodiments, the first portion 20 and second portion 22 of the clamping system 18 are hollow so that, when engaged in the engaged position, a shank of a bolt 44 of a connecting member 46 (as shown in FIG. 1 or 5) of the clamping system 18 can be inserted therethrough. As will be understood from FIGS. 1 and 5, as a nut 48 of the connecting member 46 is tightened, a head of the bolt 44 and nut 48 apply a compressive force to draw the distal ends 24, 34 of the insertion members 26, 36 of the first portion 20 and second portion 22 together and secure them in the engaged position.

In particular, load is substantially transmitted along a path though the clamping system 18 and along the axis 16, rather than along a path between the other members interconnecting the first member 6 and second member 8 and foam 54, which could otherwise cause collapse of the beam 4.

In variant embodiments, which are not illustrated, the connecting member is alternatively implemented, e.g. as a pin. In an embodiment, the first portion of the clamping system integrates the bolt. In an embodiment, the second portion of the clamping system integrates the nut. The foam may be omitted.

Referring to FIGS. 1 and 5, it will be understood that the clamping system 18 implements connection of the utility line support structure 2 to another support structure 50, such as a pole or tower, via a connecting structure implemented as a bracket 52, which can be implemented as between one or both of an outer of the flanged members 30, 40 of the first and second portions 20, 22 and the connection member 46.

Referring to FIGS. 2A-3B, the distal end 24, 34 of each insertion member 26, 36 of the first and second portions 20, 22 comprises an engagement portion 56, 58, which when engaged transfers load in an axial direction 16 between the first and second portions 20, 22.

The engagement portion 56 of the first portion 20 includes an extension 60 (which may be referred to as an insert), which is complementary in shape to a slot 62 (which may be referred to as a collar) of the engagement portion 58 of the second portion 22. In particular, the extension 60 is cylindrical with a fixed diameter, the extension 60 extending between a tip 64 and a body 66. The diameter of the extension 60 is less than the diameter of the body 66, such that a step 68 is formed at the body 66.

The engagement portion 58 of the second portion 22 includes said slot 62. In particular, the slot 62 is implemented as a cylindrical cavity that extends between a tip 70 and a body 72. The internal diameter of the slot 62 is greater than the internal diameter of the body 72, such that a step 74 is formed at the body 72.

It will be understood that the extension 60 and slot 62 are slideably engageable along axis 16 as the first and second portions are inserted through opposed holes. Once engaged, the tips 64, 70 abut opposed steps 68, 74.

The engagement portions 56, 58 of the insertion members 26, 36 are configured so that when engaged the extension 60 and slot 62 are fully inserted into each other, the insertion members 26, 36 extend with a constant peripheral diameter. That is, the peripheral diameter is composed only of the peripheral diameter of the bodies 66, 72 and the peripheral diameter of the slot 62, which are all the same magnitude.

In a similar manner, the engagement portions 56, 58 of the insertion members 26, 36 are configured so that when engaged such that the extension 60 and slot 62 are fully inserted into each other, the insertion members 26, 36 have a constant internal diameter. That is, the internal diameter is composed only of the internal diameter of the bodies 66, 72 and the interior diameter of the extension 60, which are all the same magnitude.

In variant embodiments, which are not illustrated, the engagement portions 56, 58 may be alternatively configured, for example: although the steps 68, 74 are shown as perpendicular, they may be angled; although the extension 60 and slot 62 are cylindrical they may be conical; the engagement portions 56, 58 may comprise a periphery of complementary saw teeth; the engagement portions may simply abut each other without insertion.

The flanged members 30, 40 of the first and second portions 20, 22 comprise angled edges to be countersunk in a conical hole (not shown) of the outer surface 32, 42 of the beam 4. Although the edges are angled for a conical hole, they may be alternatively shaped, including straight for insertion into a cylindrical hole, or to be implemented without counter sink.

In variant embodiments, which are not illustrated, the flanged members 30, 40 and/or a shank of the first and second portion 20, 22 include a groove for receiving a sealing member, such as an O-ring. The sealing member to prevent water ingress into the beam 4.

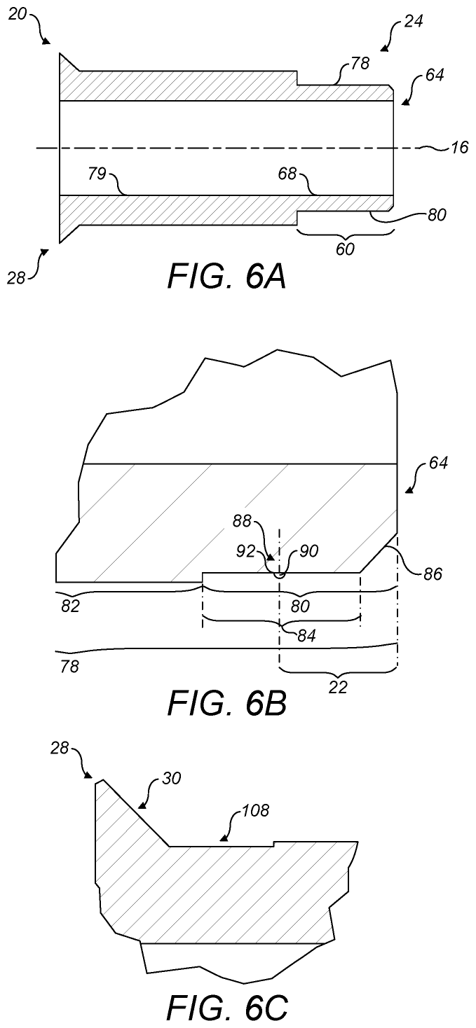

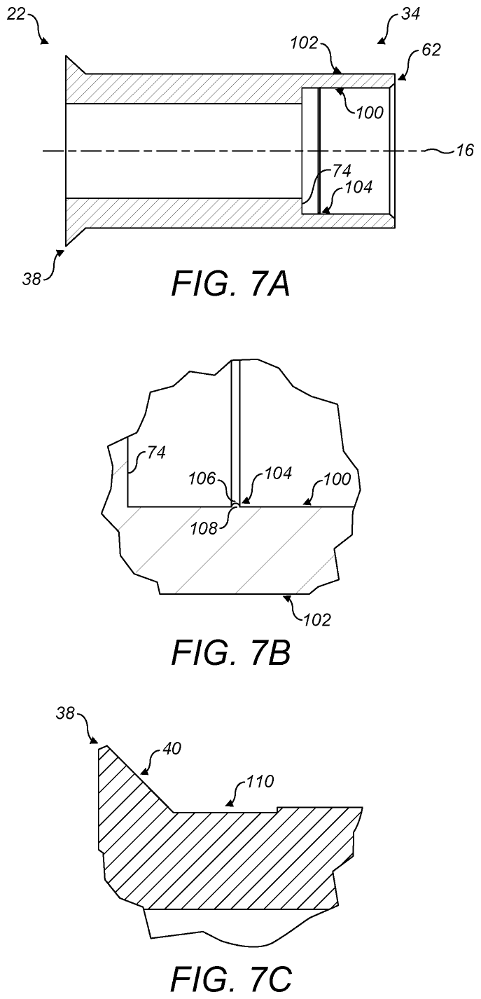

Referring to FIGS. 6A to 6C and 7A to 7C, an embodiment first portion 20 and second portion 22 are shown that implement the features of the previous embodiments or other embodiments disclosed herein.

The first portion 20 at the distal end 24 comprises the insert 60. The insert 60 has a coupling surface 78 to abut a complimentary surface of the collar 62. The coupling surface 78 is opposed to the interior surface 79 of the first portion 20. The coupling surface 78 of the insert 60 includes a tip region 80, which extends from and is proximal to the tip 64. The coupling surface 78 further includes a first region 82, which extends from the step 68 to the tip region 80. The tip region 80 includes a narrowing portion 84 of a diameter that is less, with respect to the axis 16, than a diameter of the first region 82. The end 64 of the tip region 80 implements a chamfer 86.

A ridge 88 extends from the narrowing portion 84 radially outward with respect to axis 16. The ridge 88 is semi-circular in cross-section and extends as an annulus around the circumference of the narrowing portion 84. Accordingly at a tip 90 of the ridge 88 the diameter D1 (not shown in the figure) of the ridge 86 in respect of axis 16 is greater than at the base 92 of the ridge 88. The diameter D1 at the tip 90 of the ridge 88 is less than an outer diameter of the first region 82 and is greater than the diameter of the narrowing portion 84.

In variant embodiments, which are not illustrated, the ridge 88 can have other cross-sections, including square or V-shaped. There may also be more than one ridge. The ridge can have a different diameter at the peak, including the same as or greater than the outer diameter of the first region.

Referring to FIGS. 7A and 7B, an embodiment second portion 22, to be coupled with the portion shown in FIGS. 6A and 6B, at the distal end 34 comprises the collar 62. The collar 62 has a coupling surface 100 to abut the coupling surface 78 (FIG. 6A) of the insert 60. The coupling surface 100 is opposed to an exterior surface 102 of the second portion 22.

The coupling surface 100 of the collar 62 includes a ridge 104 that extends from the coupling surface 100 radially inward with respect to axis 16. The ridge 104 is semi-circular in cross-section and extends as an annulus around the internal circumference of the coupling surface 100. Accordingly at a tip 106 of the ridge 104 the diameter D2 (not shown in the figure) of the ridge 104 in respect of axis 16 is less than at a base 108 of the ridge 104. The diameter D2 at the peak 106 is less than the outer diameter of the first region 82 (FIG. 6B) of the first portion 20, such that in the engaged configuration the ridge 104 is contained within the narrowing portion 84 of the first portion 20.

In variant embodiments, which are not illustrated, the ridge 104 can have other cross-sections, including square or V-shaped. There can also be more than one ridge. The ridge can have a different diameter at the peak, including the same as the outer diameter of the first region.

In particular, the diameter D2 at the peak 106 of the ridge 104 of the second portion 22 is selected to be less than the diameter D1 at the peak 90 of the ridge 88 of the first portion 20. In this manner the peaks overlap each other when viewed along axis 16. They can overlap by at 0.1 mm or less, or 0.5 mm or less or 1 mm or less.

In variant embodiments, which are not illustrated, D1 can be equal to D2 or D2 can be greater than D1 so that there is no overlap.

Referring to FIGS. 7A and 7B, the ridge 104 (i.e. a center point thereof) is arranged a distance L1 from the step 74. Referring to FIGS. 6A and 6B, the ridge 88 (i.e. a center point thereof) is arranged a distance L2 from the tip 64. In the engaged position the step 74 engages the tip 64. Since L1 is greater than L2, during insertion of the insert 60 into the collar 62, the ridges 88 and 104 pass over each other. Since the ridges have an overlapping diameter at their peaks 106, 90 they mechanically deform during insertion, said deformation may be elastic or plastic.

In variant embodiments, which are not illustrated, the L1 can equal L2 such that the ridges engage each other in the engaged configuration. Alternatively, L1 can be less than L2 such that the ridges do not engage each other during insertion.

In variant embodiment, which are not illustrated the ridge of the collar is arranged in a narrowing section on the coupling surface of the collar. With such an embodiment, the ridge of the insert can not be arranged in a narrowing section.

Referring to FIGS. 6C and 7C, the shanks of the proximal ends 28, 38 of the first member 20 and second member 22 include a narrowing section 108, 110, for receiving a sealing material e.g. a rubber. The sealing material may be applied by an over-moulding process. The sealing material can also be applied to the flanged members 30, 40.

In the various embodiments, the first hole 12 and second hole 14, which are through the respective first member 6 and second member 8, have a diameter of 20 mm to 40 mm, e g about 30 mm. The insertion members 26, 36 are therefore sized to fit though said holes. Although both holes and insertion members are illustrated as the same size, they can be different sizes.

The present invention is also a method of assembling a utility line support structure 2. This method comprises inserting the insertion member 26 of the first portion 20 of the clamping system 18 through the first hole 12 in the fiber reinforced beam 4 and into the interior 10 of said beam 4, inserting the insertion member 36 of the second portion 22 of the clamping system 18 through the second hole 14 in the fiber reinforced beam 4 and into the interior 10 of said beam 4, engaging the flanged members 30, 40 of the first and second portions 20, 22 with outer surfaces 32, 42 of the beam 4, engaging distal ends 24, 34 of the insertion members 26, 36 with each other, and inserting a connection member 40 through the first and second portions 20, 22.

The method is executed at a different location to where the holes 12, 14 are formed. For example, the method is executed at the location of the pole/tower and the holes are formed at a manufacturing plant. Alternatively, the holes are formed at the location where the method is executed, e.g. at the location of the pole/tower.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

We claim:

1. A utility line support structure comprising:
a fiber-reinforced beam having a first member and a second member, an interior of said fiber-reinforced beam being between at least the first member and the second member, the fiber-reinforced beam having or receiving at least one pair of holes, the at least one pair of holes including a first hole arranged in the first member and a second hole arranged in the second member, wherein a central axis of the first hole and a central axis of the second hole are aligned; and
a clamping system having a first portion and a second portion, wherein the first portion has the insertion member at a distal end thereof adapted for insertion through the first hole and into the interior of the fiber-reinforced beam, a proximal end of the first portion having a flanged member of greater diameter than the first hole, the first portion being arrangeable in an engaged position in which the insertion member is inserted through the first hole with the flanged member engaging an outer surface of the first member of the fiber-reinforced beam, wherein the second portion of said clamping system has another insertion member at a distal end thereof adapted for insertion through the second hole and into the interior of the fiber-reinforced beam, a proximal end of the second portion having a flanged member of greater diameter than the second hole, the second portion being arrangeable in an engaged position in which the another insertion member is inserted through the second hole with the flanged member of the second portion engaging an outer surface of the second member of the fiber-reinforced beam, wherein distal ends of the insertion members of the first portion and the second portion engage each other when the first portion and the second portion are in the engaged position.

2. The utility line support structure claim 1, wherein the first portion and the second portion are hollow and adapted to receive a connecting member therethrough when the first portion and the second portion are in the engaged position.

3. The utility line support structure of claim 2, wherein the connecting member comprises a bolt having a head at a first end and a thread at a second end, the thread threadedly engaging a complementary threaded member so as to clamp the flanged members of the first and second portions to the first and second members of the beam in order to mount the utility line support structure to a pole or tower.

4. The utility line support structure of claim 1, wherein each of the insertion members has an engagement portion that transfers load in an axial direction between the first and second portions.

5. The utility line support structure of claim 4, wherein the engagement portion is configured to restrain axial relative movement of the first and second portions in opposed directions.

6. The utility line support structure of claim 4, wherein the engagement portion of the first portion is complementary in shape to the engagement portion of the second portion.

7. The utility line support structure of claim 6, wherein the engagement portions of the first and second portions are slidably engageable.

8. The utility line support structure claim 7, wherein one of the engagement portions of the first and second portions for one of the engagement portions of the first and second portions has a collar that receives an insert of the other of the engagement portions of the first and second portions, wherein a first end or a second end of the collar abuts a first end or a second end of the insertion portion in the engaged position.

9. The utility line support structure of claim 8, wherein the engagement portions of the insertion members are configured with a peripheral diameter substantially the same as a peripheral diameter of the remainder of the insertion members when in the engaged position.

10. The utility line support structure of claim 9, wherein the engagement portions of the insertion members have an inner diameter substantially identical as the interior an interior diameter of the remainder of the insertion members when in the engaged position.

11. The utility line support structure of claim 10, wherein a coupling surface of the insert or the collar includes a cut-out portion, the cut-out portion having a ridge, the cut-out portion arranged at the tip region of the insert or the collar.

12. The utility line support structure claim 11, wherein another of the insert or collar which does not include the cut-out portion has a ridge extending from a coupling surface thereof and is dimensioned for accommodation in the cut-out portion.

13. The utility line support structure of claim 12, wherein the ridges of the collar and the insert are arranged to overlap with each other when viewed along a central axis thereof.

14. The utility line support structure claim 11, wherein the insert has the cut-out portion as a narrowing section, the narrowing section extending from a first region which defines the coupling surface, the ridge extending radially outwardly from the narrowing section and having a peak diameter which is less than a diameter of the first region.

15. The utility line support structure of claim 14, wherein the coupling section of the collar has a ridge arranged proximal a base of the collar, wherein the ridge extends in a radially inward direction from the coupling surface and extends to a diameter suitable for accommodation within the narrowing section of the insert.

16. The utility line support structure claim 1, wherein the fiber-reinforced beam has a foam material arranged between the first member and the second member.

17. The utility line support structure of claim 1, further comprising:
a tower or pole extending from the utility line support structure.

18. A method of assembling a utility line support structure, the method comprising:
inserting a first insertion member of a first portion of a clamping system into a first hole in a fiber-reinforced beam and into an interior of the fiber-reinforced beam;
engaging a flanged member of the first portion with an outer surface of the beam;
inserting a second insertion member of a second portion of the clamping system through a second hole in the fiber-reinforced beam and into the interior of the fiber-reinforced beam;
engaging a flanged member of the second portion with an outer surface of the fiber-reinforced beam; and
engaging distal ends of the first and second insertion members with each other.

19. The method of claim 18, further comprising:
inserting a bolt through the first and second portion; and
connecting the bolt to a tower or pole.

20. The method of claim 19, further comprising:
forming the first and second holes at a customer-desired location, wherein the customer-desired location is different than a location of forming at least one of the one hole is different than the location of the first and second holes of the clamping system and fiber-reinforced beam.
